(19) United States
(12) Patent Application Publication
(10) Pub. No.: US 2026/0099515 A1
(43) Pub. Date: Apr. 9, 2026

(54) AUTOMATED PROMPT GENERATOR USING DIFFERENTIAL EVOLUTION AND CHAIN OF THOUGHT

(71) Applicant: Genpact USA, Inc., New York, NY (US)

(72) Inventors: Divyanshi Yadav, Uttar Pradesh (IN); Varsha Rani, Gurgaon (IN); Prakash Selvakumar, Bangalore (IN); Sreekanth Menon, Bangalore (IN)

(21) Appl. No.: 18/906,759

(22) Filed: Oct. 4, 2024

(51) Int. Cl. G06F 16/332

(52) U.S. Cl. CPC G06F 16/3329; G06F 16/3326

(57) ABSTRACT

A method and system for automatically generating prompts is disclosed. In some embodiments, the method includes providing user input to large language models (LLMs) utilizing meta prompting to generate a set of prompts represented by vectors. The method includes the LLMs identifying differential vector(s) from the vectors, mutating the vectors with the differential vector(s), and using first algorithm(s) to determine mutated prompt vector(s).

The method includes generating an intermediate prompt by combining the mutated prompt vector(s) with the set of prompts and selecting a prompt vector using second algorithm(s). The method also includes dividing a task of validating the intermediate prompt into subtasks. The method further includes performing the subtasks by the software-based agents as part of a chain of thought (CoT) process to validate the intermediate prompt and outputting suggestion(s), and generating a final prompt by refining the intermediate prompt using the suggestion(s).

### TECHNICAL FIELD

This disclosure relates to machine learning, in particular, to using artificial intelligence models to automatically generate prompts based on differential evolution, chain of thought, and other optimization techniques.

### BACKGROUND

A prompt may be input to an artificial intelligence (AI) system, which provides instructions to the AI system to generate an intended output. Based on how a prompt is phrased, the AI system may provide various outputs. Accurate and well-formatted prompts are critical to providing sufficient information to the AI system to generate coherent and contextually relevant responses.

Crafting a prompt describing a task with a clear instruction and format is essential to ensure that the AI system understands the context, purpose, and requirements of the task that the AI system should perform. Some challenges may present when a prompt is not adequately formed. For example, users may receive ambiguous, irrelevant, or incorrect responses, resulting in inefficient communications, miscommunications, or even the spread of harmful or damaging information. In some cases, a poorly designed prompt may lead to biased or offensive output, negatively impacting user experience and trust in the AI system. Additionally, creating an effective AI prompt can be particularly complex and difficult for ordinary users.

Hence, an automatic prompt generation mechanism that can be employed to optimize prompt creation, e.g., ensuring that prompts are both relevant and well-structured, is desirable.

### SUMMARY

To address the aforementioned shortcomings, a method and a system for automatically generating prompts using differential evolution and chain of thought (CoT) is disclosed herein. The method provides user input to one or more large language models (LLMs) utilizing meta prompting to generate a set of prompts represented by a plurality of vectors. The method identifies, by the one or more LLMs, a plurality of differential vectors from pairs of prompt vectors selected from the plurality of vectors representing the set of prompts. The method also mutates, by the one or more LLMs, the plurality of vectors representing the set of prompts with the plurality of differential vectors and using one or more first algorithms to determine one or more mutated prompt vectors, and generates an intermediate prompt, using the one or more LLMs, by combining the one or more mutated prompt vectors with the plurality of vectors representing the set of prompts and selecting a prompt vector representing the intermediate prompt using one or more second algorithms. The method further divides a task of validating the intermediate prompt into a plurality of subtasks to be respectively performed by each of a plurality of software-based agents, and performs the plurality of subtasks by the plurality of software-based agents as part of a CoT process to validate the intermediate prompt and output one or more suggestions for prompt modification. The method generates a final prompt by refining the intermediate prompt using the one or more suggestions.

To output the one or more suggestions, one or more LLMs are used to execute the intermediate prompt on validation data and generate an execution result. The validation data is different from the user input. The intermediate prompt is then analyzed based on the execution result, and the one or more suggestions are outputted from analyzing the intermediate prompt by the one or more LLMs. In some embodiments, a plurality of test cases are dynamically created using the one or more LLMs, and the final prompt is evaluated based on executing the final prompt on test data of the plurality of test cases. In some embodiments, an evaluation score is generated based on evaluation of the final prompt on the plurality of test cases, and the final prompt is presented to a user when the evaluation score exceeds a threshold score. In some embodiments, user feedback is received to refine the final prompt when the evaluation score does not exceed the threshold score. The final prompt is refined by adjusting hyperparameters of the LLMs or manually enhancing the final prompt with domain-related information. In some embodiments, one or more steps can be iterated. These steps include providing the user input to the LLMs to generate the set of prompts, identifying the differential vectors, mutating the vectors representing the set of prompts with the differential vectors, generating an intermediate prompt, dividing a task of validating the intermediate prompt into subtasks, performing the subtasks, or generating the final prompt.

The one or more algorithms are applied to ensure each differential portion obtained from the one or more LLMs is included in the one or more mutated prompt vectors. The one or more algorithms include an objective function. In some embodiments, the set of prompts, the intermediate prompt, and the final prompt are generated based on the one or more LLMs receiving and recognizing domain-specific data using the CoT.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION OF THE DRAWINGS

The disclosed embodiments have advantages and features that will be more readily apparent from the detailed description, the appended claims, and the accompanying figures (or drawings). A brief introduction of the figures is below.

FIG. 1 illustrates an exemplary procedure currently used to generate a prompt for an AI system.

FIG. 2 illustrates an exemplary adaptive prompt generation process, according to some embodiments.

FIGS. 3A-3F illustrate an exemplary use case for adaptive prompt generation, according to some embodiments.

FIG. 4 illustrates an exemplary table for comparing the adaptive prompt generation approach with other prompt generation approaches, according to some embodiments.

FIG. 5 illustrates a flowchart of automatically generating prompts using optimization techniques including a chain of thought, according to some embodiments.

FIG. 6 illustrates a block diagram of an example computer system that may be used in implementing the technology described herein, according to some embodiments.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Overview

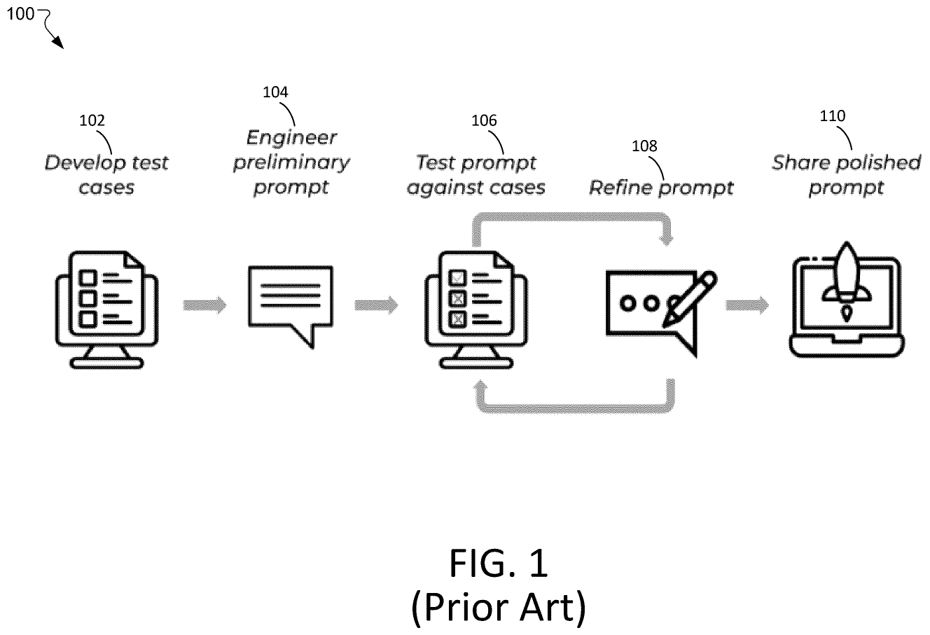

FIG. 1 illustrates an exemplary procedure 100 currently used to generate a prompt for an AI system. As depicted, prompt engineering procedure 100 is a time-consuming process that includes a series of steps. First, various test cases need to be developed such that a preliminary prompt may be generated, as shown in 102 and 104. The generated preliminary prompt is tested at 106 against the generated cases to obtain a test result. This test result is further used to refine the prompt at 108. These steps are repeated until a polished prompt 110 can be shared among users. Procedure 100 also requires specific knowledge, inference, and/or operations in each step 102-110. For example, to generate an effective prompt, users/teams must understand the underlying pattern in input data. In addition, knowledge about formatting the input expected by an AI model is required, and manual efforts are needed in prompt testing and error correction operations.

While many approaches may be used to generate prompts, they all have some shortcomings. For example, prompts may be manually created. Individuals may come up with their own ideas, questions, or statements and manually create prompts for an AI language model. This manual-crafting approach allows for creativity and customization, but it is time-consuming and labor-expensive.

Templates may be developed and used to generate prompts. Such templates consist of pre-defined structures or formats that may be filled with relevant information, enabling the quick creation of numerous prompts. However, the prompts generated utilizing templates are extremely generic and thus have limited adaptability to new or different types of tasks and domains that may require more specialized prompts.

Data-driven techniques may be employed to automatically generate prompts from existing data sources such as news articles, web pages, or social media posts. This approach facilitates the discovery of new and diverse prompts based on real-world data but may limit its scalability and applicability for certain use cases.

Using crowdsourcing approaches, a wide variety of prompts may be generated by soliciting input from many individuals and gathering diverse perspectives. Although these approaches may generate prompts based on diverse opinions, they often cannot adequately represent the complexity of a specific task with synthetic datasets and thus cannot properly regularize the prompt generation. The prompts may also be overfitted, that is, they may fit too well to the collected opinions and fail to adapt to new, unseen data. The prompts generated using crowdsourcing approaches therefore cannot guide an AI system to generate a meaningful and coherent result in response to both current and future data in a client environment.

Alternatively, AI-powered tools or platforms may be employed to automatically generate prompts based on specific inputs or criteria. These tools often use advanced algorithms and natural language processing techniques (e.g., large language model (LLM)) to create prompts. These AI-generated prompts, however, are often sub-optimal. For example, the prompts may be effective for initial input data but cannot adapt to data changes. The AI tools currently applied in prompt generation may lack the ability to identify an optimal data format, and thus fail to recognize data from different domains and generate prompts appropriate for multiple domains. Additionally, clients/users may not be able to properly format inputs required by an AI system to generate an expected prompt.

To address the aforementioned problems, the present system utilizes advanced algorithms and machine learning techniques to automatically generate prompts. In some embodiments, the present system may use a chain of thought approach and optimization techniques (e.g., differential evolution) to generate effective prompts for various tasks. The present system may analyze queries from users and generate prompts that are more likely to produce an expected output.

An AI prompt (referred to hereafter as a “prompt”) includes certain input provided to an AI system to initiate a response. To enable a desired output from the AI system, a prompt is expected to be clear and direct. The prompt may include one or more of a question, a command, a statement, etc. Particularly, the prompt may include an example to provide explicit context to the AI system. The prompt should also be specific and precise with step-by-step instructions, where each step may focus on specific traits (e.g., features, patterns, shapes) that the AI system aims to generate. In general, the AI system includes one or more AI models (e.g., ChatGPT®). The role of each model (e.g., AI agent for performing a specific task) needs to be included in the prompt, and the prompt should define output formats.

In some embodiments, the present system may be utilized to generate multiple prompt versions for a given task, and different prompt versions make it easier to evaluate a variety of initial prompt variations in an arbitrary use case. The prompts generated by the present system may also be taken as an improved initial template and utilized as a starting point for the iteration of other prompt-generation processes.

In some embodiments, the system and method disclosed herein may employ one or more LLMs to recognize and interpret the received data, capture patterns from the data, generate instructions to replicate the captured patterns, enhance the generated instructions with a chain of thought, and output a high-quality prompt that includes the enhanced instructions. The present prompt generation system and method not only enhances the accuracy and effectiveness of an AI system (e.g., AI models) but also saves time and effort for users, leading to an overall improved AI system and user experience.

Advantageously, the present system provides an end-to-end automation approach that streamlines the process of prompt generation and evaluation. In some embodiments, the present system may employ a meta-prompt structure to ensure compatibility and effective instructions for AI models (e.g., LLMs), and use a chain of thought to refine prompts based on validation results. The present system may also use a differential evolution (DE) approach to leverage the strengths of high-performance AI models. In this way, the present system may balance generality with specific context for optimal results. The generated prompts are accurate and structured prompts that capture intricate details, as well as data-driven prompts that adapt to specific contexts.

The present system outperforms other prompt generation services in other aspects. For example, the adaptive prompt generation disclosed herein may provide versatility across numerous fields and thus cater to a diverse range of use cases. Additionally, the AI system applied herein may support compatibility with a wide range of AI models, which further expands the application of the present system in various use cases. The disclosed approach also includes high-performance and low-latency operations, which may significantly reduce the prompt generation time and increase the efficiency of prompt generation. For example, manual efforts to analyze data patterns are eliminated, and minimal human intervention ensures the efficiency and consistency of prompt generation results.

### Adaptive Prompt Generation Solution

The adaptive prompt generation approach described herein includes an advanced AI-based system that generates high-quality prompts for various tasks and use cases by utilizing a chain of thought approach and optimization techniques (e.g., differential evolution). This approach aims to provide optimal prompts tailored to users/clients'specific needs such that the users/clients may interact with one or more AI models effectively and conveniently.

In some embodiments, the present system may generate an initial prompt based on user inputs using meta-prompting. A meta-prompt is a specific type of instruction provided to an AI system/model, which emphasizes the structure and composition of the prompt itself to outline how prompt elements should be organized to guide the AI system in producing a desired output. The present system may then refine the prompt using a chain of thought (CoT). Using the CoT, the present system can break down the complicated prompt optimization problem into smaller, more manageable steps to accelerate the problem-solving of obtaining high-quality prompts. Additionally, the present system may employ optimization techniques such as differential evolution (DE) to further refine and improve the generated prompts.

The iterative process of prompt generation process described herein may ensure that the final prompt aligns closely with specific user requirements and meets desired standards. In some embodiments, the present system may also evaluate the prompt's effectiveness using one or more custom evaluation functions, and provide suggestions on how to apply the prompt to get better responses from the AI system.

The present system is designed to be applicable across a wide range of tasks. For example, these tasks may include summarization, entity extraction, sentiment analysis, coding, etc. The present system may generate prompts adaptable in both specific and generic use cases, making the present system a versatile and valuable tool for AI users/clients. Additionally, by streamlining the process of prompt generation and refinement, the present system may maximize the utility of AI models, expand users'understanding of how prompts work, and optimize the usage of AI models for different tasks.

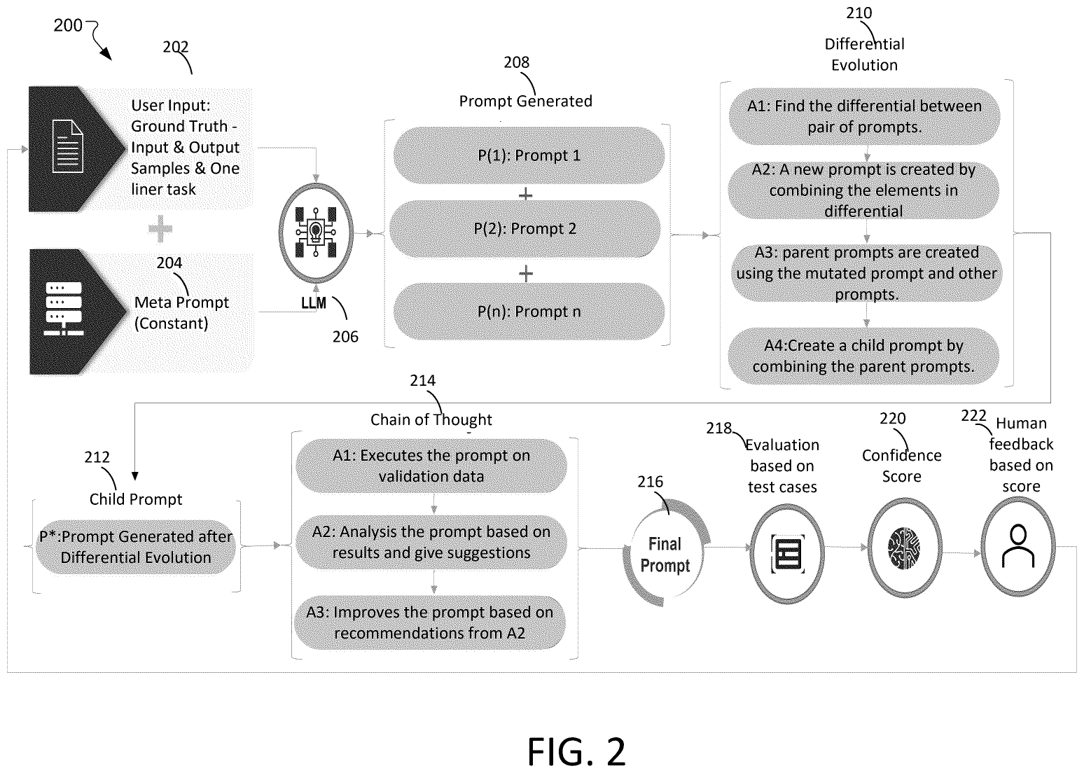

FIG. 2 illustrates an exemplary adaptive prompt generation process 200. The prompt generation process 200 may be implemented by incorporating techniques such as chain of thought (CoT), meta-prompts, and differential evolution into an advanced AI-based system to generate high-quality prompts. As depicted, process 200 may include multiple steps 202-220.

At step 202, the present AI-based system may take input from one or more users. The input generally includes dataset(s) of “ground truth” that serves as the reference for the data an AI model is expected to process. In some embodiments, the input may include a task description (e.g., in a one-line sentence/phrase) that specifies a task that the user(s) wants to perform. The task may include, but is not limited to, generating accurate summaries, translating languages, performing text classification, generating creative texts, answering questions, etc. The prompts crafted by the system may be used to guide one or more AI models (e.g., LLMs) to effectively perform this task.

The input may also include data or context relevant to the task. For example, a user input identifies an invoice processing task. This means a system may receive invoices, parse the invoices, identify patterns, and extract and output certain key values (e.g., invoice number, item description, purchase order, etc.). In other words, the user requesting the invoice processing task expects that a specific output (e.g., key values) could be generated from processing each specific input (e.g., invoice). In some embodiments, the user may provide input & output pairs to the AI models (e.g., LLMs). Each input & output pair may include an example input the AI model(s) is likely to encounter in a real-world scenario, paired with the corresponding expected output. The input & output pairs are selected to represent the diverse range of situations, complexities, and nuances in an operational environment. These input & output pairs may serve as prior examples to the LLMs to instruct the language models to comprehend the task and craft meaningful prompts at step 206.

It may be impractical for an AI system to obtain an output in an effective manner when a massive amount of data (e.g., invoices) is received. In some embodiments, samples of input & output pairs may be collected and applied to the LLMs at 206. The samples are used as a limited number of task examples and a description of prompt to enable intricate pattern recognition and improve prompt generation. For example, pairs of 10 inputs and 10 outputs may be provided to the LLMs to influence the subsequent prompt generation by the LLMs.

The chosen samples may be representative of the larger set of samples so that the present system is able to discern and understand the underlying patterns and relationships between the input data and the expected output. By analyzing the examples and performing intricate pattern recognition, the present system allows the AI models to generate prompts that accurately reflect and reproduce the observed trends, thereby enhancing the ability to predict or generate appropriate responses or outputs in a wide array of situations. This approach ensures that the AI models (e.g., LLMs) can handle the variability and intricacies across a variety of tasks, leading to reliable and contextually appropriate outcomes.

In addition to the task description (e.g., one line) and input & output samples, at step 204, a meta prompt may also be provided as part of the input to the AI models (e.g., LLMs at 206) to generate prompts. A meta prompt is an example-agnostic structured prompt designed to capture the reasoning structure of a task (e.g., the task identified at step 202) or a category of tasks. It outlines the general approach to performing the task, enabling the AI models (e.g., LLMs) to fill in specific details as needed.

Rather than focusing on specific content, a meta prompt emphasizes the structure and composition of the prompt generated by the AI models or LLMs. That is, the meta prompt is an instructional framework used to guide the AI models'behavior, ensuring outputs from the LLMs are relevant and safe. A meta prompt may cover four key areas influencing AI behavior. The meta prompt may create a profile of the LLMs by defining the purpose and boundaries of the AI system. It may specify a response format or output format from the LLMs. It may also provide behavior examples, e.g., examples of intended behavior, to the LLMs. It may further determine safety and ethical guidelines, e.g., safety and behavioral guardrails, applied to the LLMs. A meta prompt helps format information and obtain prompts for new structured data without knowledge of the data. It is generally not infallible and requires regular validation.

A meta prompt is applied as an advanced prompt to guide the language model in generating superior quality prompts that are specifically tailored to unique tasks and requirements. However, the meta prompt is not merely a prompt. The meta prompt acts as catalyst that simplifies the process of initiating an interaction with an AI model. It is particularly beneficial to help users in understanding and effectively utilizing AI techniques when they are at the early stages of using AI models. The meta prompt not only facilitates the effective use of AI models but also helps in broadening users'understanding of how prompts work and how they can be optimized for different tasks.

Responsive to receiving user input (e.g., task description and input & output pairs), at step 206, the AI models utilizing meta prompting may be used to obtain an initial prompt tailored to the user's specific task and requirements. In some embodiments, the AI model includes one or more LLMs. An LLM is a type of AI program that can perform natural language processing such as classification, recognizing and generating text, etc. For example, the LLMs may be applied to comprehend the underlying data (e.g., invoice data) and generate an output (e.g., key values extracted from the data). An LLM may be a pre-trained open-source data model built upon publicly available data sets. For example, an LLM can be GPT®, Claude®, Gemini®, Falcon®, Cohere®, etc. One skilled in the art should recognize any open-source or other appropriate LLMs may be used to implement the functionalities described herein.

In some preferred embodiments, the present system includes multiple LLMs. A combination of LLMs may help recognize domain data to generate prompts that are applicable to new data. The prompts generated from current AI approaches often work for initial threads and data but cannot adapt to new (e.g., future) data because these approaches fail to understand domain data and format the data appropriately.

When an LLM is used to perform a specific task, different cores may be used. A core refers to the central component of an AI system, which lies in the intricate patterns and relationships a model can learn from diverse language data and enables the system to make the most accurate predictions. A core may include one or more AI models. Different cores may lead to different prompts p(1), p(2), . . . p(n) as shown in 208 of FIG. 2, where n is a positive integer (e.g., n=3). For example, GPT®, Gemini®, and Claude® may be the cores applied by the present system to generate the prompts in 208. Since different cores may characterize different model behaviors and/or comprehend the task in different ways, using different cores in initial prompt generation at step 208 may lead to differential prompts that on the whole capture the most details (e.g., patterns, features) from the input data. These initial prompts may be further optimized using, for example, DE and CoT, to obtain a final prompt.

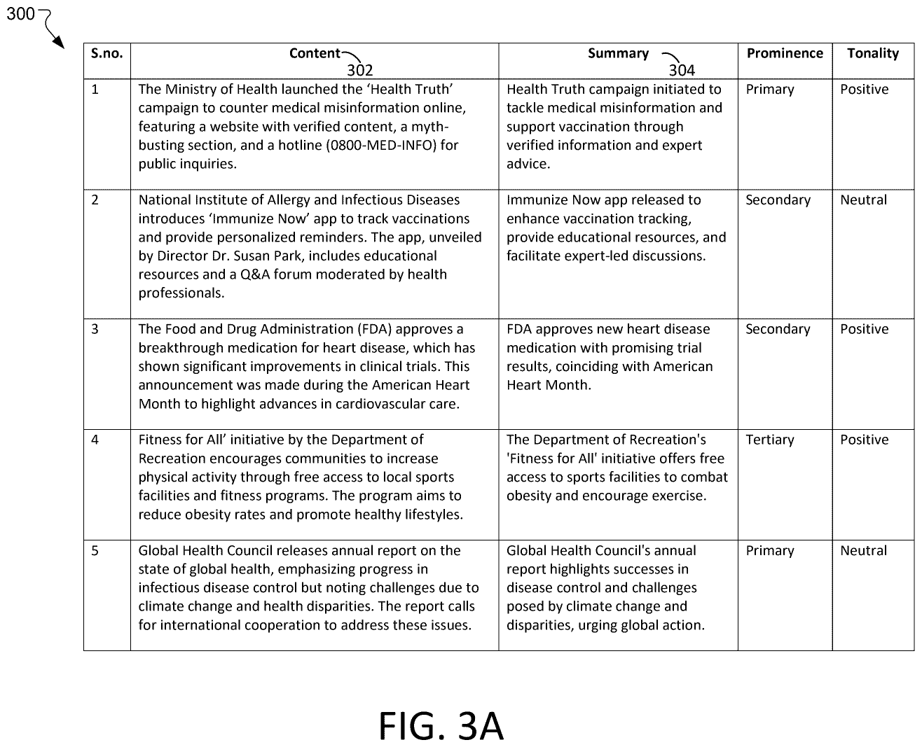

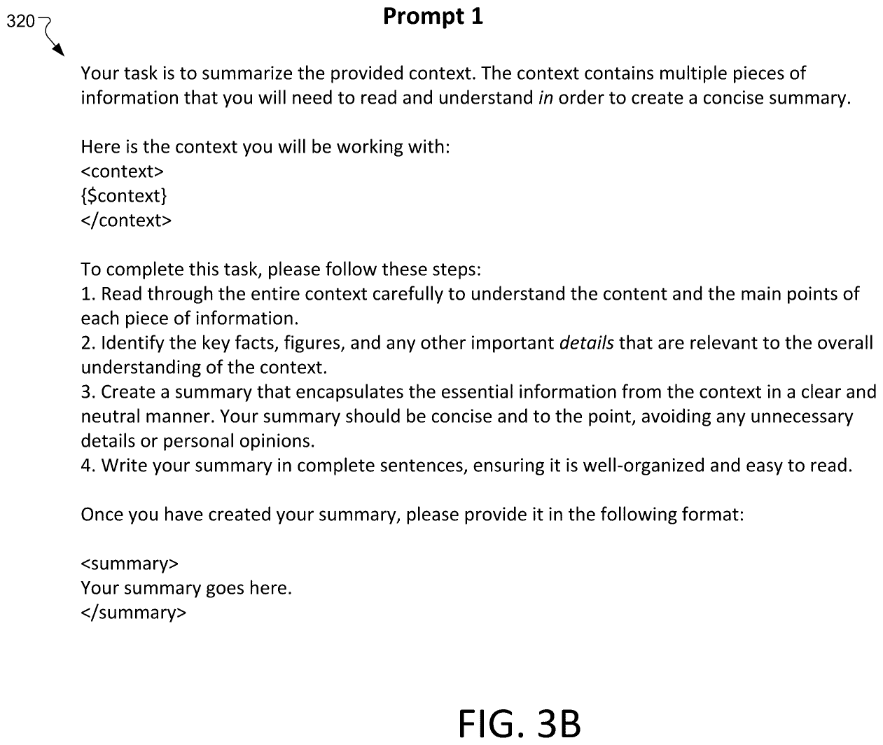

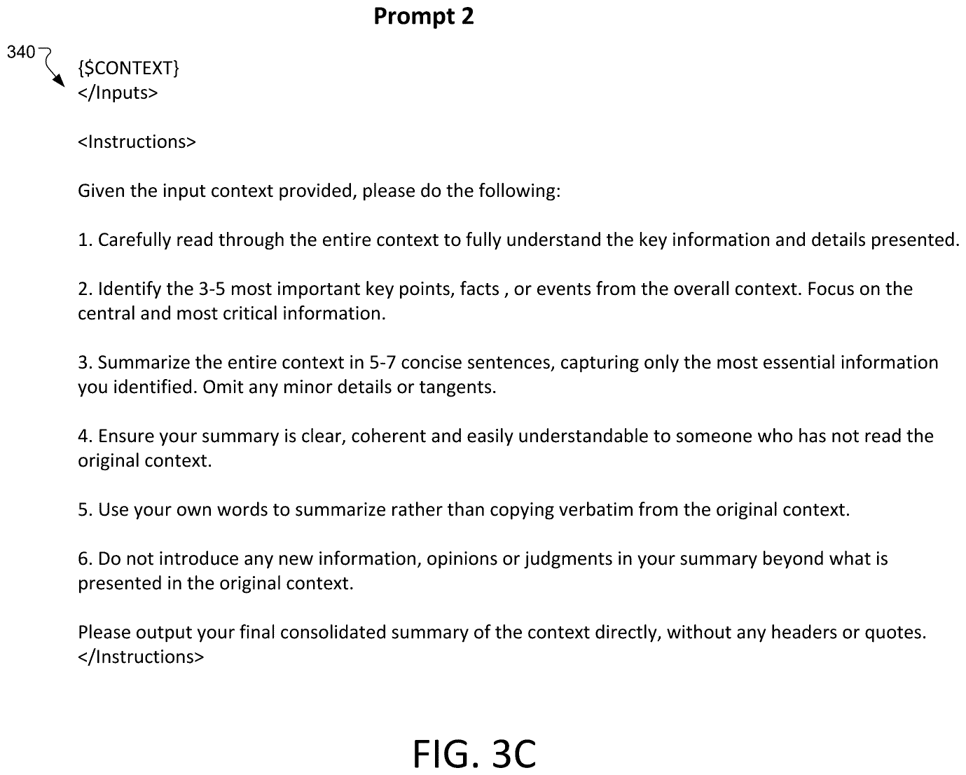

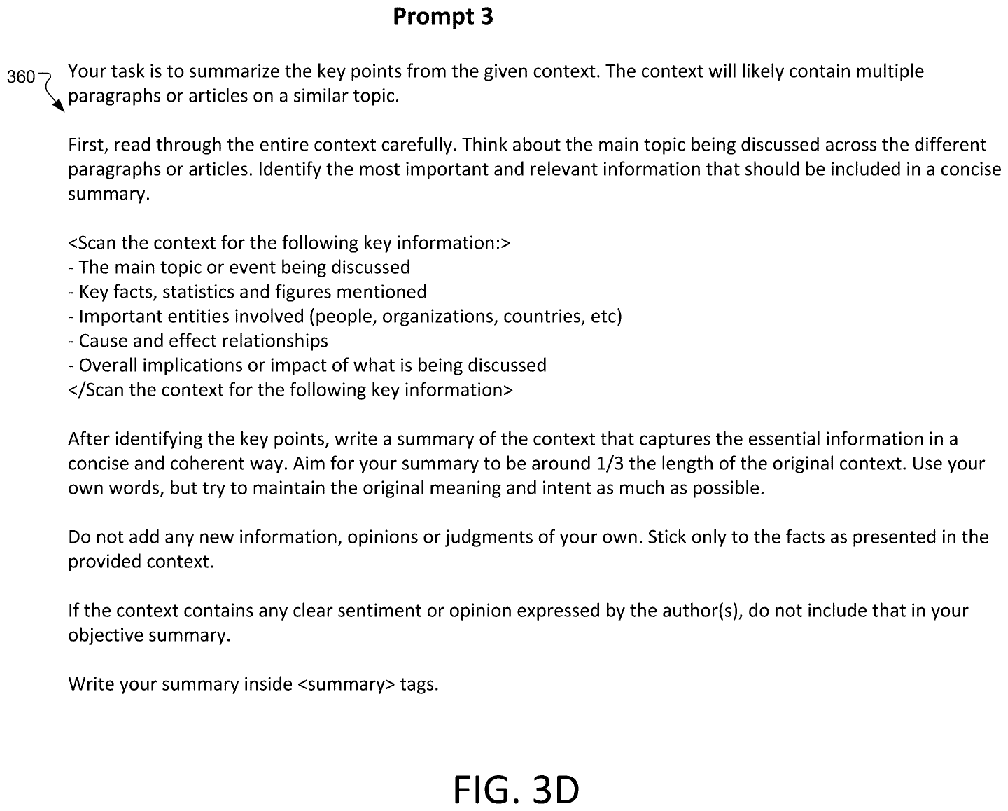

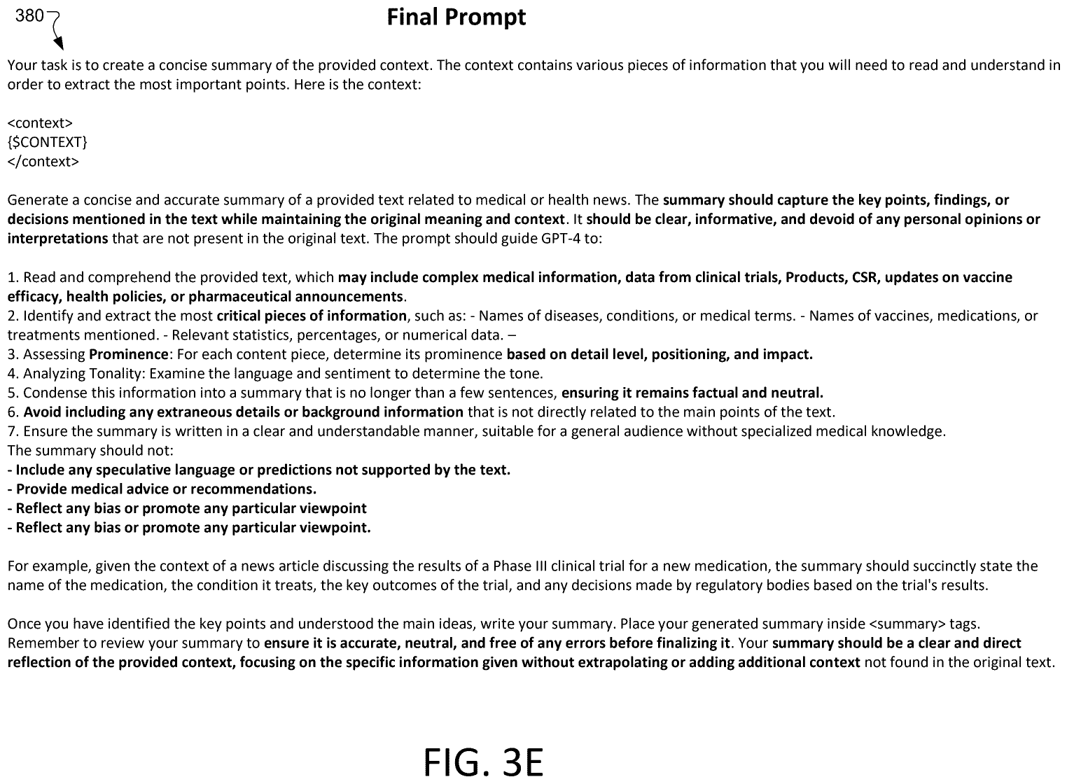

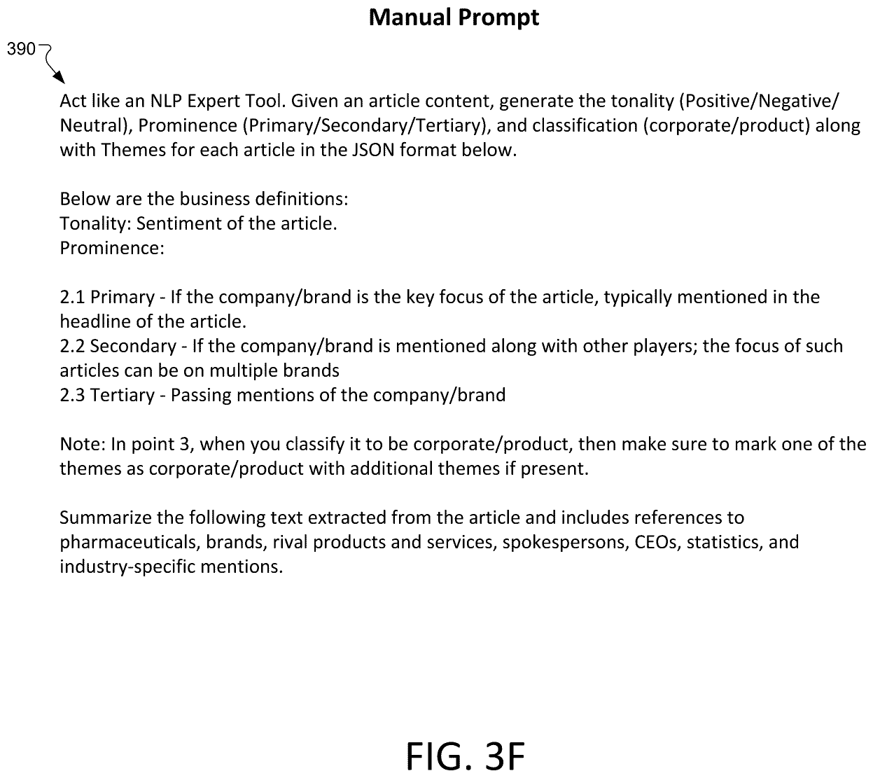

FIGS. 3A-3F illustrate an exemplary use case for adaptive prompt generation, according to some embodiments. In this example case, the AI system is prompted to perform a summary generation task based on the content provided. FIG. 3A shows content samples inputted into the AI models and summaries expected from the AI models in table 300. The content (e.g., 302) may include data of a domain-specific nature, e.g., medical data including medical terminologies. The present system aims to generate meaningful and coherent prompts such that the AI models provided with the domains-specific data in 302 may generate high-quality summaries in 304.

As discussed above in steps 202-208 of FIG. 2, in some embodiments, n initial prompts are generated, which can be further improved to determine a final prompt. FIGS. 3B-3D show prompts 320, 340, and 360, i.e., three initial prompts (n=3) determined based on data related to the content in table 300 of FIG. 3A. Each initial prompt includes unique features that can be used to generate a final prompt. Given the complexity of the task, however, each prompt in FIGS. 3B-3D may not capture all the details of the content in FIG. 3A. For example, the first prompt in 320 of FIG. 3B may not get sufficient information to capture specific patterns, and the second prompt in 340 of FIG. 3C includes more information but may not adapt to new data. Such prompts when used to instruct the AI models'behavior may cause gaps between an actual result and a predicted result, and these gaps may be filled in by applying DE, CoT, and evaluation steps in 210-222.

### Differential Evolution (DE)

Referring back to FIG. 2, the present system may optimize the initial prompts p(1), p(2), . . . p(n) at step 208 (e.g., prompts 320, 340, and 360 in FIGS. 3B-3D) at step 210. In some embodiments, a differential evolution (DE) technique may be applied to refine and improve the initial prompts. Instead of using the gradient of a problem being optimized, the DE optimization applied herein is used for multidimensional real-valued functions. This indicates DE does not require an optimization problem to be differentiable, as required by classic optimization methods (e.g., gradient descent methods, quasi-newton methods). DE therefore may be used on optimization problems that are non-continuous, noisy, varying (e.g., changing over time), etc.

DE may optimize a problem by maintaining a population of candidate solutions, creating new candidate solutions (e.g., based on combining existing candidate solutions according to one or more formulas), and identifying and keeping the candidate solution that has the best score or fitness on the optimization problem. In this way, the optimization problem can be treated as a black box that merely provides a measure of quality given a candidate solution (the gradient is therefore not needed).

In some embodiments, to refine and improve prompts, the DE optimization may involve population, differential, mutation, and selection, followed by crossover. The population may include the initial set of prompts. As shown in step 210 of FIG. 2, all the initial prompts (e.g., p(1), p(2), . . . p(n) in 208) may be taken to DE optimization. For example, if n=3, DE may determine the population of three prompts, where:
p(1)=“I want to extract tables from pdfs. Make it accurate and ignore non-health related information,”
p(2)=“Extract tables from pdf. The pdfs are health-based docs,” and
p(3)=“Extract tables from pdf. I want tables in key-value pairs.”

The present system may find the difference between each pair of the n prompts by identifying unique element(s) from each prompt. In some embodiments, each prompt pair may be selected sequentially. Continuing with the above example, each sequentially-selected pair includes the pair of first and second prompts, the pair of second and third prompts, and the pair of first and third prompts. The corresponding differential elements may include:
Difference 1=p(1)-p(2)=“Make it accurate and ignore non-health-related information,”
Difference 2=p(2)-p(3) =“The pdfs are health-based docs,” and
Difference 3=p(1)-p(3) =“Make it accurate and ignore non-health-related information, I want tables in key-value pairs.

While the present system may use a different method to select prompt pairs, it ensures that all the details/features from different models can be captured even if one model may have missed some important features when generating an initial prompt.

Next, the present system may apply DE to use the differential elements to construct a new, mutated prompt. For example, the mutated prompt from the above-identified differential portions may be “Make it accurate and ignore non-health-related information. The pdfs are health-based docs. I want tables in key-value pairs.”

The present system may then select the initial prompts and combine the selected initial prompts with the mutated prompt to obtain a set of (e.g., ≤n) parent prompts. For example, two parent prompts may be p(1) and p(2) selected from the three prompts in combination with the mutated prompt. That is,
Parent 1=p(1)+mutated=“I want to extract tables from pdfs. Make it accurate and ignore non-health-related information. The pdfs are health-based docs. I want tables in key-value pairs,” and
Parent 2=p(2)+mutated=“Extract tables from pdf. The pdfs are health-based docs. Make it accurate and ignore non-health-related information. I want tables in key-value pairs.”

The DE implementation may crossover the parent prompts to create a child prompt. In some embodiments, by combining the parent prompts and/or removing duplicate(s) from the combined parent prompts, at step 212, the present system may output a child prompt p*. For example, the child prompt from the above parent (1) and parent (2) may be “I want to extract tables from pdfs. Make it accurate and ignore non-health related information. The pdfs are health-based docs. I want tables in key-value pairs. Make it accurate and ignore non-health related information.”

The DE optimization process is iterative and may be repeated until a final prompt aligns closely with the user's requirements and meets the desired standard. The present system applies differential evolution in prompt generation to progressively refine and improve the prompts, resulting in a more accurate and precise output.

In some embodiments, the present system may perform a population initialization operation by constructing a population of candidate prompt vectors from the initial prompts and selecting pairs of prompt vectors from the population of candidate prompt vectors. Each pair of prompt vectors can be selected. Other selection methods may also be used to select prompt pairs. The present system may then perform differential and mutation operations by identifying differential portions (differences) from each pair of prompt vectors and perturbing the initial prompt vectors based on the differences between the prompt pairs. In some embodiments, these operations may lead to a mutated prompt vector. The present system may then perform crossover and selection operations to mix and match the mutations or changes in the mutated prompt vector with the initial prompt vectors and evaluate the mixed or combined prompt vectors to create a new prompt or child prompt.

In some embodiments, the present system may use one or more algorithms to define a unique strategy for each of differential, mutation, selection and crossover operations. For example, distinct features may be obtained from prompting generation using each LLM model, and these algorithms may be applied to ensure each of these distinct features are included in the mutated prompt. The algorithms may be used to identify and remove the duplicate features. The algorithms may also include configuring an objective function to select an appropriate child prompt.

### Chain of Thought (CoT)

Next, the present system may move to step 214 to further optimize the child prompt, e.g., by validating the child prompt using a CoT approach. The CoT approach allows a technical problem to be broken into smaller, more manageable steps. For example, solving a complex math equation typically involves several sub-steps, each of which is essential to arriving at a final correct answer. As described herein, CoT prompting may instruct an LLM to mimic the process of decomposing a problem and working through the prompt generation process step by step. Essentially, CoT allows the AI model to “think out loud,” rather than simply providing a direct solution.

CoT prompting is effective because it takes advantage of an LLMs' capabilities (e.g., a sophisticated ability to generate fluent language) and simulates successful techniques from human cognitive processing (e.g., planning and sequential reasoning). In addition, CoT prompting enables complex reasoning capabilities through intermediate reasoning steps. By combining CoT with few-shot prompting, the present system may obtain better results on more complex tasks that require reasoning before responding.

CoT in prompt generation is a systematic and iterative procedure that refines the initial output from a language model. At step 214, the present system may perform CoT prompting by refining an output from the AI models through prompt processing, comparison, suggestion generation, prompt modification, and iteration. In some embodiments, the present system may perform validation using the CoT to achieve complex reasoning capabilities and better results, which is especially useful for those tasks (e.g., coding, generating summary) that require reasoning before responding.

As earlier mentioned, prompt processing, comparison, suggestion generation, prompt modification, and iteration may be implemented for CoT prompting. In the initial stage of prompt processing, the present system may generate a preliminary/initial output using a language model (e.g., LLMs) and an initial prompt (e.g., child prompt 212). In the second stage of comparison, the present system may compare the initial output with an expected or real output based on factors including accuracy, relevance, creativity, etc. The present system can therefore identify any areas of discrepancy or shortcomings in the candidate output/prompt compared to the expected output. Based on the comparison stage, the present system may generate improvement suggestions. These suggestions may include altering certain parts of the candidate output, incorporating new information, or restructuring a response. Once the improvement suggestions are obtained, the present system may utilize the AI models (e.g., LLMs) to modify the initial prompt based on these suggestions, such that the present system may steer the AI models towards producing a more appropriate or accurate output when the modified prompt is used. The CoT process is iterative. For example, the second and subsequent stages may be repeated until an output from the modified prompt aligns closely with an expected output or meets the desired standards. This CoT approach allows for a continuous improvement loop in prompt generation, progressively enhancing the outputs as the process iterates.

In some embodiments, the present system may apply the CoT to run the child prompt 212 received from the DE optimization 210 on new, validation data. The present system may utilize one or more agents to evaluate a validation result and provide one or more suggestions to further improve the prompt. An AI agent is an autonomous intelligent system that performs a specific task without human intervention. In some embodiments, the present system may divide a task of validating the child prompt into a plurality of specific tasks and configure one or more agents to perform each specific task. As shown in FIG. 2, three agents (A1, A2, A3) may be used in this CoT-based prompt validation at step 214. A1 is an agent used to validate data. That is, A1 may receive and execute the newly generated prompt (e.g., child prompt 212) on validation data. The validation data may include new data samples that the LLMs 206 have not yet collected. A1 may output a validation result generated from the AI system after using this new, child prompt 212. For example, for an invoice processing task, the validation result may include key values extracted from the validation data (e.g., new invoices) provided to the AI system (e.g., LLMs). For a summary generation task, the validation result may include a summary derived from the validation data (e.g., new content) provided to the LLMs. In either case, the newly generated child prompt 212 is used to guide the LLMs'behavior in processing the validation data.

A2 may receive the validation result and analyze the child prompt 212 based on the result. A2 may identify any gap left between the validation result and an expected output, and further provide suggestions. In some embodiments, A2 may rely on LLMs to determine an appropriate suggestion. For example, if purchase detail is not captured in the validation result as compared to the user-desired output, A2 may suggest adding such detail.

A3 may incorporate the suggestions or recommendations received from A2 to the child prompt 212 to obtain an improved prompt, e.g., a final prompt 216. In some embodiments, LLMs may be employed to perform reasoning logic and implement the agent(s) in order to determine the specific way to incorporate the suggestions or recommendations.

Suppose initial prompts 320, 340, and 360 in FIGS. 3B-3D are used to generate a child prompt. This child prompt is executed on validation data using a CoT approach to output a summary at step 214. A1, A2, and A3 may work together to analyze this outputted summary as compared to a predicted or expected summary to generate suggestions. Example analysis of the predicted output and real output, discrepancies determined from the analysis, and suggestions for improvement are shown in the following:

### Predicted Output Analysis:

The predicted output provides a comprehensive summary of the COVID-19 vaccine situation in Mexico, Bolivia, and Brazil. It includes details about Mexico surpassing 100 million vaccine doses, negotiations with other countries, phase 3 clinical trials, and the potential authorization of the Cuban vaccine Abdala. It also mentions the issues faced by indigenous communities in Bolivia with vaccine distribution and the release of new vaccines in Brazil by Anvisa.

### Real Output Analysis:

The real output contains three separate summaries, each focusing on a specific country. The summary for Mexico mentions surpassing the 100 million vaccine threshold and the approval of various clinical trials but does not mention the aim to receive 150 million doses or the negotiations with other countries. The summary for Bolivia focuses on a specific incident in Uru Chipaya where vaccines did not arrive as planned, without mentioning the broader “irregularities” in vaccine distribution. The summary for Brazil is concise, mentioning the release of new vaccines by Anvisa without the additional context of the donation by the United States or the arrival at Viracopos International Airport.

### Discrepancies:

The predicted output includes broader context and additional details not present in the real output summaries.
The real output summaries are more focused on specific events or updates without the broader context provided in the predicted output.
The predicted output mentions Mexico's aim for 150 million doses and negotiations with other countries, which are not present in the real output.
The real output for Bolivia focuses on a specific incident, whereas the predicted output discusses general “irregularities” in vaccine distribution.
The real output for Brazil is more concise and lacks the context of the vaccines being donated by the United States and the specific airport involved.

### Suggestions for Improvement:

Ensure that the summary includes only information present in the provided context, as per the guidelines;
Focus on specific events or updates as presented in the real output, rather than providing additional context or broader details not included in the context;
Maintain a neutral tone and avoid including any information that is speculative or not directly stated in the context.
Adjust the prompt to emphasize the importance of sticking to the facts presented in the context and avoiding the inclusion of external information or broader implications unless explicitly mentioned.
Encourage the AI to provide summaries that are as specific and event-focused as the real output, which may be more useful for readers looking for updates on a particular situation

The above suggestions are explicit and comprehensive, and may significantly improve the generated prompt. A well-formed prompt should be clear and direct, and include examples and step-by-step instructions, etc. In some embodiments, the present system may iterate the CoT validation process, DE optimization, one or more other steps 202-222, or the entire prompt generation procedure 200 to refine the intermediary prompts (e.g., initial prompts 208, child prompt 212) such that a final prompt at 216 can pass the subsequent evaluation process (described below in steps 218, 220, and 222). The final prompt 216 should align with user requirements and meet the desired standard(s). An example final prompt used for summary generation is shown in 380 of FIG. 3E.

The CoT approach assists in improving prompt generation because it adds domain data and trending information into the prompt generation process. Multiple prompts are generated at step 208 and DE is applied to identify and compensate for the deficiencies of model outputs at step 210, but occasionally important information may still be missed. For example, domain-specific data was unavailable when prompts were first generated, but domain entity data were added in the later iterations, causing the generated prompt insufficient to adapt to new data. CoT may get the domain-specific data into the AI models as iteration goes on to learn from the new data and further enhance the generated prompts.

In some embodiments, one or more of A1, A2, and A3 may include LLM cores. It should be noted, however, that these agents are not general-purpose LLMs. Instead, they are LLMs defined with specific roles for performing a specific task configured by the present system. For example, for a new prompt for a new use case, A1 is configured to execute the new prompt on the new data/sample and provide an insight into predicted output, A2 is configured to analyze and assess A1's output, and A3 is configured to provide intelligence about the improvement suggestions.

In some embodiments, the AI models (e.g., LLMs 206) may be used to generate initial prompts, as well as improve the prompts using DE and CoT. LLMs 206 may further be applied in evaluation step 218 (described below). In some embodiments, one or more LLMs (e.g., GPT) may be selected to perform certain functions. In other embodiments, a different set of AI models may be utilized in performing different functions including generating initial prompts, improving prompts, evaluating prompts, etc.

The final prompt 216 may not be presented to the requesting user until an evaluation process indicates it satisfies certain criteria. In some embodiments, the present system may evaluate the effectiveness of the generated prompt using one or more custom evaluation functions at step 218. In some embodiments, the present system may utilize one or more LLMs to dynamically create test cases and run prompt 216 on the data of these test cases. For example, the difference between a predicted result and the actual result from running prompt 216 on specific data samples may be evaluated. In some embodiments, the present system may perform the evaluation based on a variety of aspects such as precision, applicability, completeness, etc., and determine an evaluation score. The evaluation score reflects an overall performance and satisfaction level of running the prompt 216 on each test case with respect to the evaluated aspects. This may help identify improvement area(s) and provide users with suggestions on how to use the prompt for better results.

In some embodiments, a final evaluation score (e.g., confidence score 220) may be computed as an average of the evaluation scores from each of the test cases. A threshold score (e.g., 80) may be specified. When a confidence score 220 exceeds this threshold score, the present system may determine a successful prompt has been generated and there is no need for further iteration. Otherwise, the present system may receive human feedback to improve the generated prompt and/or repeat one or more prompt generation steps. It should be noted the entire prompt generation procedure 200 may be iterative, meaning the CoT, DE optimization, and evaluation steps can all be repeated until the output from the modified prompt meets the desired standards or closely aligns with the expected output.

In addition to the CoT, DE, and evaluation steps outlined above, the present system may also employ a human feedback mechanism at step 222 (e.g., based on confidence score 220), ensuring that the generated prompts are effective as well as relevant and meaningful to users. In some embodiments, the present system may employ human feedback either to adjust the hyperparameters of AI models or to manually enhance the prompt with specific domain-related information. For example, the hyperparameters, such as the number of iterations in the chain of thought, the number of input and output samples used for initial prompt generation, or the number of prompts used for mutation and crossover in differential evolution, may be adjusted by the present system based on human evaluators to further improve the system performance. This collaboration between AI and human expertise may result in a more robust and reliable prompt generation system, tailored to users'specific needs and enhancing the overall AI experience.

Referring now to the example use case of summarizing medical data in FIGS. 3A-3F, a final prompt 380 generated by the present system is shown in FIG. 3E, and a manual prompt 390 is shown in FIG. 3F. Based at least on the comparison with manual prompt 390, the present system may evaluate final prompt 380. For example, the precision evaluation may show that the output accurately summarizes the situation in Bogotá (mentioning the ICU occupancy rates, vaccination efforts, and the impact of the National Strike), correctly identifies Sarclisa as a new treatment option for multiple myeloma in Spain (including its indications), reports the decrease in Covid-19 cases and deaths in Mexico and the fines for travelers in Canada with false documents, etc. The applicability evaluation shows that the output summary is applicable as it provides a concise overview of the various situations related to Covid-19 and health issues in different locations. The completeness evaluation shows that the output summary is comprehensive (covering all the key points from the test cases) but some details (e.g., the specific vaccines used in Bolivia, the types of vaccines used for boosters in Salvador, the waiting time for medicines in Campina Grande, and the effectiveness of different vaccines in the rise of cases in Asia and Europe) are not mentioned. In addition, the output summary does not include the quotes from health professionals regarding Sarclisa in Spain (a minor omission), and does not mention the vaccines approved for entry into Canada (which was part of the test case).

The present system may then determine an overall efficacy and associated confidence score 220. This confidence score may be computed based on evaluation against the expected output of each test case (e.g., a summary of vaccination progress in one or more countries, a summary of vaccine distribution in one or more countries, a summary of research on treatments for certain diseases, etc.). For example, the confidence score determined for the final prompt 380 in FIG. 3E is 85 (out of 100). It reflects the high level of precision and applicability of the summary (resulted from the application of final prompt 380), but acknowledges the minor omissions and lack of certain details that would provide a more complete picture.

The application of human feedback depends on whether the confidence score is greater than a threshold score. One or more steps of prompt generation procedure 200 may also be iterated depending on the evaluation result. Once the final prompt (e.g., 380 in FIG. 3E) has been successfully evaluated, it may be provided to the user.

### Prompt Output Analysis

The present system discloses a seamless integration approach for creating high-quality, task-specific prompts that effectively address users'needs while simplifying their interaction with AI models. By constantly refining and evaluating prompts through an iterative process, the present system may ensure optimal alignment with user requirements and desired outcomes. The approach described herein is applicable across a diverse range of tasks and use cases. Additionally, this advanced system holds the potential to enhance users'AI experience, empower users with a deeper understanding of prompts, and optimize users'AI usage across various tasks, ultimately unlocking the full potential of AI technology.

One of the diverse range of tasks is a task of analysis in the domain of finance. The goal of the approach described herein is to identify and summarize key patterns and movements within financial markets or specific financial instruments. To begin, the present system may define this task in a concise and precise manner. For example, a task prompt tailored by the disclosed advanced prompt generation system may be:
“Your task is to analyze and summarize prominent trends in a given financial context. The context will contain diverse data points and information that you must parse and interpret to identify meaningful trends. Here is the context:
{$CONTEXT}
Craft a concise and insightful summary of financial trends related to stock market movements, economic indicators, or investment strategies. The summary should distill the essential elements, such as market trends, economic data, or shifts in investment tactics while preserving the original content's intent and context. It should be informative, devoid of personal opinions or interpretations not supported by the data. The prompt should guide the analysis to:
Read and comprehend the provided financial context, which may include complex data regarding market performance, economic reports, investment products, or financial forecasts.
Identify and extract the most critical pieces of financial information, such as:
Names of relevant financial instruments or markets.
Significant numerical data or percentage changes.
Economic indicators that influence market trends.
Statements or forecasts made by financial analysts or institutions.
Assess the Significance: For each piece of content, determine its significance based on the level of impact, specificity, and relevance to the broader financial landscape.
a. Primary (P): Directly related to the main financial trends and highly impactful.
b. Secondary (S): Relevant but less central, with moderate impact or detail.
c. Tertiary (T): Indirectly related with minimal impact or detail.
d. Not Given (nan): When information is insufficient to determine significance.
Analyse Sentiment: Evaluate the tone of the information to understand the market sentiment.
a. Bullish (BU): Reflects positive market sentiment or expectations of growth.
b. Neutral (NL): Neither particularly positive nor negative; factual and unbiased.
c. Bearish (BE): Reflects negative market sentiment or expectations of decline.
d. Not Given (nan): When sentiment cannot be determined from the information provided.
Summarize the trends in a brief narrative, ensuring it remains factual and neutral, and is no longer than a few sentences.
Exclude any irrelevant details or background information not directly related to the identified trends.
Present the summary in a clear, comprehensible manner, suitable for both financial experts and a general audience without specialized financial knowledge.

The summary should not:
Include speculative statements or forecasts not grounded in the provided context.
Offer financial advice or investment recommendations.
Show bias or favor any particular financial theory or market.
For instance, given the context of a financial report on the quarterly performance of the tech sector, the summary should succinctly state the overall performance trend, key contributing economic indicators, and significant stock movements or changes in market capitalization for major companies within the sector.
After pinpointing the essential elements and grasping the main insights, write your summary. Place your generated summary inside tags.
Ensure that your summary accurately reflects the provided context, focusing solely on the specific information given without introducing additional material not found in the original text.”

As a comparison, a manually-created task prompt is also listed below:
“Act as a Financial Analysis Assistant. Given financial report content, generate the sentiment (Bullish/Bearish/Neutral), Significance (Primary/Secondary/Tertiary), and classification (market/economic indicator) along with Key Themes for each report in the JSON format below.

Below are the financial definitions:
Sentiment: The tone of the report indicates the market outlook.

Significance:
2.1 Primary—If the report focuses primarily on a single market or financial instrument.
2.2 Secondary—If the report discusses multiple markets or instruments.”

The analysis based on the comparison between manual prompting and automatic prompting is detailed below.

As to time and effort for creation, the automatically generated prompt was produced in minutes (<15 minutes), indicating a faster, more efficient process with minimal human intervention. The manually written prompt, on the other hand, required a week to test, iterate, and finalize. This process involves significant manual effort, suggesting a more thorough and deliberate approach used to craft the prompt to meet specific requirements and standards.

Regarding complexity and detail, the automatic prompt is more generalized, focusing on creating a concise and accurate summary of given content (e.g., medical or health news) without going into the specifics of how to structure the output. That is, a user does not need to consider anything beyond the content to be summarized. The manual prompt, in contrast, provides detailed instructions on analyzing the text, including the assessment of tonality, prominence, and specific themes. The manual prompt also specifies the output format (JSON), demonstrating a higher level of complexity and specificity in what is expected from the result.

Considering focus and application, the automatic prompt is designed with a broad application in mind, aiming at summarizing content (e.g., financial texts) without specifying any particular focus on companies, brands, or themes. The manual prompt is tailored to a specific business context, focusing on analyzing articles for sentiment, prominence, and themes related to the company/brand. This indicates a targeted approach, likely intended to serve specific analytical or business intelligence purposes.

As to output format, the automatic prompt does not specify an output format, leaving it open to interpretation but suggesting the summary be placed within summary tags. The manual prompt explicitly requires the output to be in JSON format, with detailed instructions on how to classify and structure the information. This requirement for a structured format aligns with the need for data that can be easily processed or integrated into existing systems or workflows.

For guidance on content analysis, the automatic prompt provides general guidelines on summarizing content, emphasizing neutrality and factual accuracy without delving into how to categorize the information. The manual prompt offers detailed definitions and criteria for tonality and prominence, guiding users on how to analyze and categorize the content specifically, which suggests a more analytical and nuanced approach to summarizing the text.

These differences highlight the trade-offs between speed and simplicity versus depth and precision in prompt creation. The automatically generated prompt offers a quick and broad solution, while the manually written prompt provides a detailed, customized approach tailored to specific analytical needs.

### Advantages

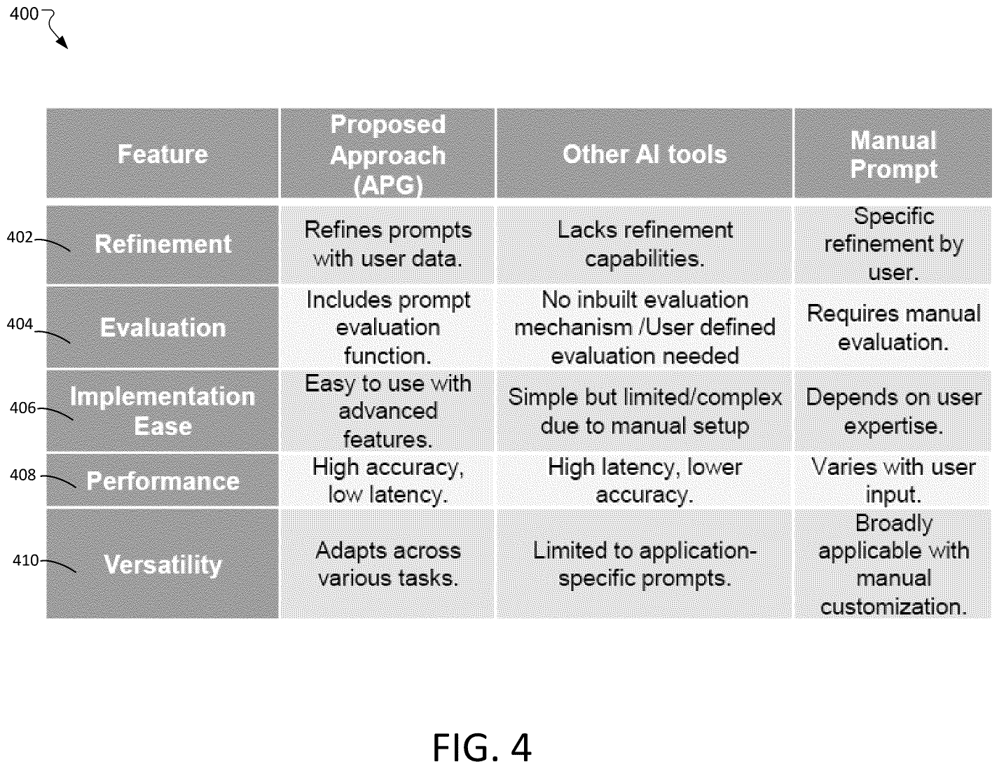

In addition to the above analysis between auto-generated prompts and manual prompts, there are other advantages of the AI prompts automatically generated by the present advanced prompt generation system using the prompt generation procedure 200 in FIG. 2. table 400 including comparisons with other prompt generation approaches are shown in FIG. 4.

The present system generates versatile, model-compliant prompts for optimal results. For example, the present system may ensure that some AI models (e.g., Claude) receive a certain format of prompt to generate an optimal result. The present system may also use the meta prompt to ensure that the generated prompt is generic and compliant with each AI model. The present prompt-generation approach is also suitable for a variety of use cases. For example, the present system may generate effective prompts for tasks such as named entity recognition (NER), coding, entity extraction, answering questions, summarization, sentiment analysis, etc., where task results from executing the generated prompts are closely aligned to the ground truth. The prompt generation described herein also addresses the drawbacks of other services such as lacking CoT, requiring technical knowledge, and/or time-consuming (e.g., 40 minutes) to obtain a result, etc. In addition, the prompt generated using the disclosed approach is a generic detailed prompt as it balances details in instructions. The present system does not add exact details to the prompt and thus avoids overfitting. On the other side, the prompt can still capture patterns and statements to reproduce the same result and avoid underfitting. The present system may further save time and effort by streamlining prompt generation processes, for example, creating and testing a prompt within a reduced time.

It should be noted that the integration of DE and CoT into the prompt generation process, as described herein, illustrates the importance of optimization and cognitive emulation in AI applications. DE ensures that the evolutionary process of refinement leads to the most effective prompts, while the CoT approach ensures that the AI models'processing of these prompts mimics human reasoning as closely as possible. This strategy not only enhances the quality of AI-generated outputs but also expands the potential applications of AI in complex fields, making technology more accessible and useful for a wider range of users. In summary, the final prompt, refined through DE and enriched by the CoT approach, represents a significant advancement in the use of AI for complex summarization tasks. It underscores the potential of combining optimization algorithms with cognitive modeling to improve AI's utility and reliability, particularly in domains where precision and accuracy are non-negotiable.

As shown in table 400 of FIG. 4, the present system provides adaptive prompt generation that outperforms in various aspects such as refinement 402, evaluation 404, implementation ease 406, performance 406, and versatility 408. The present adaptive prompt generation can be applied for a variety of use cases based on a variety of techniques such as DE, CoT, and meta prompt. The present system may use DE to obtain the power and capacity of the n best AI models in the technical field, use CoT to further refine and validate results, and use meta prompt structure to help generate a prompt that is compatible, structured, and optimal to instruct the AI system (e.g., LLMs). The present system also allows the AI models to iterate through the data, understand the patterns, and capture the reproducible features, thereby providing data-driven prompts. Moreover, the present system adapts and evolves prompts in real time, and thus provides high-quality prompts with low latency.

### Flowchart

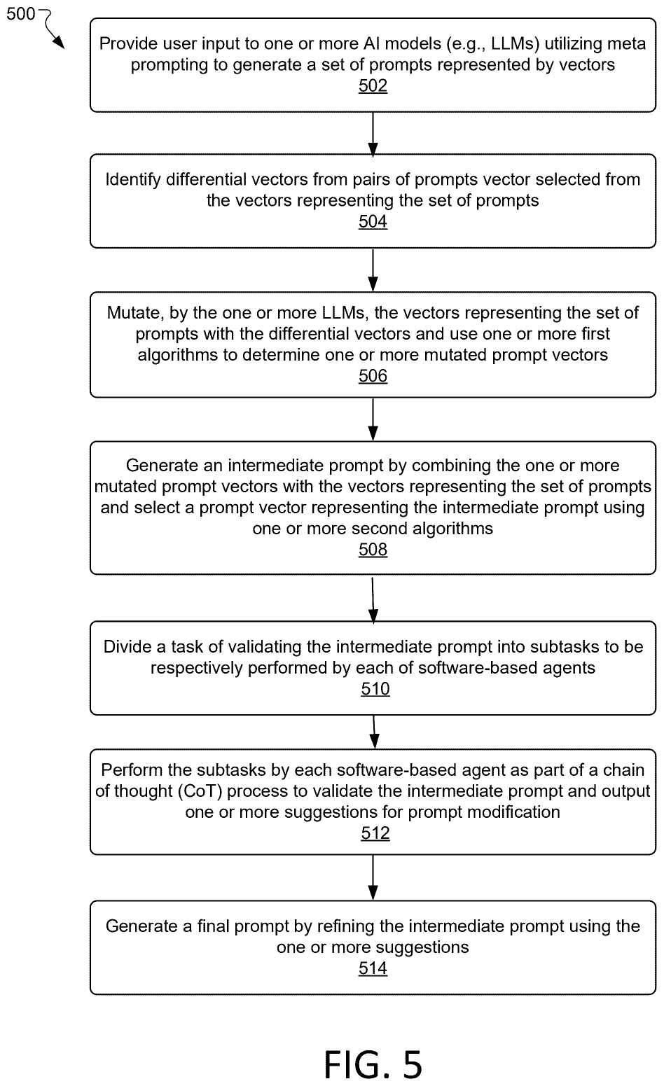

FIG. 5 illustrates a flowchart 500 of automatically generating prompts using a chain of thought, according to some embodiments. At step 502, the present system provides user input to one or more AI models (e.g., LLMs) that utilizes meta prompting. In response, the one or more LLMs may generate multiple vectors representing a set of prompts (e.g., initial prompts 208 in FIG. 2). In some embodiments, user input and meta prompts may be inputted to the LLMs to instruct LLM's behavior to perform a task (e.g., summary generation, text translation, entity recognition). The user input may include sample pairs of input context and user-desired output corresponding to the input context. The one or more LLMs may include GPT®, Claude®, Gemini®, Falcon®, Cohere®, etc. Meta prompting is used to meta prompt to ensure that the generated prompt is generic and compliant with each AI model.

At step 504, the present system identifies differential vectors from pairs of prompts vector selected from the multiple vectors representing the set of prompts. At step 506, the present system uses the one or more LLMs to mutate the multiple vectors representing the set of prompts with the differential vectors and use one or more first algorithms to determine one or more mutated prompt vectors. At step 508, the one or more LLMs is then used to generate an intermediate prompt by combining the one or more mutated prompt vectors with the multiple vectors representing the set of prompts and select a prompt vector representing the intermediate prompt using one or more second algorithms. In some embodiments, the first and second algorithms are used to define the unique strategy for differential, mutation, and selection operations. For example, the algorithms may be used to ensure each of the distinct features are included in the mutated prompt, identify and remove the duplicate features, etc.

At step 510, the present system divides a task of validating the intermediate prompt into subtasks to be respectively performed by each of software-based agents. At step 512, the present system uses each software-based agent to perform the subtasks as part of a chain of thought (CoT) process to validate the intermediate prompt and output one or more suggestions for prompt modification. In some embodiments, the present system may use the one or more LLMs to execute the intermediate prompt on validation data and generate an execution result, wherein the validation data is different from the user input initially provided to the one or more LLMs. The present system may analyze the intermediate prompt based on the execution result and provide the one or more suggestions by the one or more LLMs from analyzing the intermediate prompt.

At step 514, the present system may generate a final prompt by refining the intermediate prompt using the one or more suggestions. In some embodiments, the present system may dynamically create a plurality of test cases using the one or more LLMs and evaluate the final prompt based on executing the final prompt on test data of the plurality of test cases. The present system may further generate an evaluation score based on evaluation of the final prompt on the plurality of test cases and present the final prompt to a user when the evaluation score exceeds a threshold score.

### Computer Implementation

In some examples, some or all of the processing described above can be carried out on a personal computing device, on one or more centralized computing devices, or via cloud-based processing by one or more servers. Some types of processing can occur on one device and other types of processing can occur on another device. Some or all of the data described above can be stored on a personal computing device, in data storage hosted on one or more centralized computing devices, and/or via cloud-based storage. Some data can be stored in one location and other data can be stored in another location. In some examples, quantum computing can be used, and/or functional programming languages can be used. Electrical memory, such as flash-based memory, can be used.

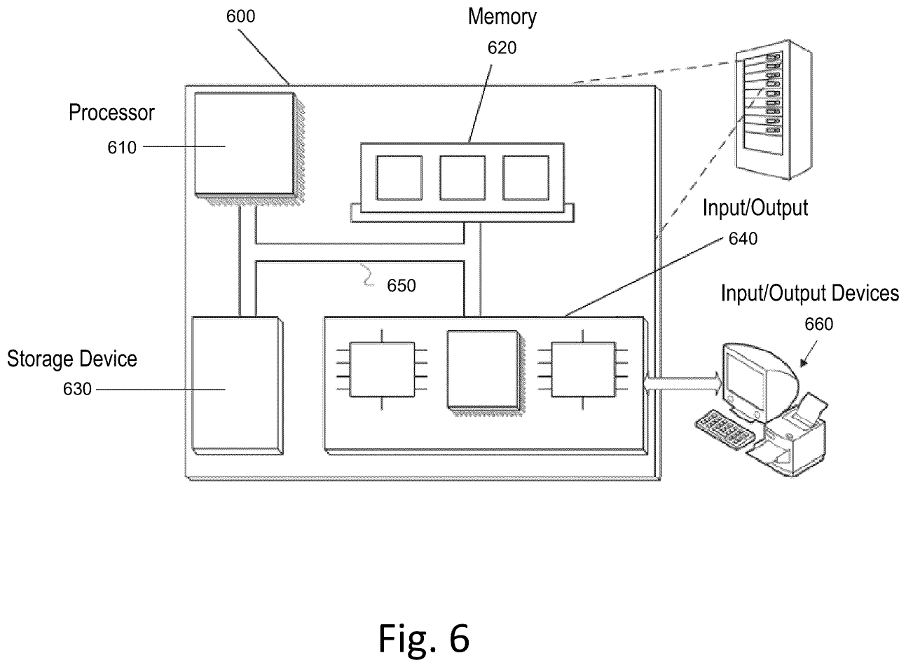

FIG. 6 is a block diagram of an example computer system 600 that may be used in implementing the technology described herein. General-purpose computers, network appliances, mobile devices, or other electronic systems may also include at least portions of the system 600. The system 600 includes a processor 610, a memory 620, a storage device 630, and an input/output device 640. Each of the components 610, 620, 630, and 640 may be interconnected, for example, using a system bus 650. The processor 610 is capable of processing instructions for execution within the system 600. In some implementations, the processor 610 is single-threaded. In some implementations, the processor 610 is a multi-threaded processor. The processor 610 is capable of processing instructions stored in the memory 620 or on the storage device 630.

Memory 620 stores information within the system 600. In some implementations, the memory 620 is a non-transitory computer-readable medium. In some implementations, the memory 620 is a volatile memory unit. In some implementations, the memory 620 is a non-volatile memory unit.

The storage device 630 is capable of providing mass storage for the system 600. In some implementations, the storage device 630 is a non-transitory computer-readable medium. In various implementations, the storage device 630 may include, for example, a hard disk device, an optical disk device, a solid-state drive, a flash drive, or some other large-capacity storage device. For example, the storage device may store long-term data (e.g., database data, file system data, etc.). The input/output device 640 provides input/output operations for the system 600. In some implementations, the input/output device 640 may include one or more network interface devices, e.g., an Ethernet card, a serial communication device, e.g., an RS-232 port, and/or a wireless interface device, e.g., an 602.11 card, a 3G wireless modem, or a 4G wireless modem. In some implementations, the input/output device may include driver devices configured to receive input data and send output data to other input/output devices, e.g., keyboard, printer, and display devices 660. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, executable code, or other instructions stored in a non-transitory computer-readable medium. The storage device 630 may be implemented in a distributed way over a network, such as a server farm or a set of widely distributed servers, or may be implemented in a single computing device.

Although an example processing system has been described in FIG. 6, embodiments of the subject matter, functional operations, and processes described in this specification can be implemented in other types of digital electronic circuitry, in tangibly embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to a suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special-purpose logic circuitry, e.g., an FPGA (field programmable gate array) or an ASIC (application-specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program can include, by way of example, general or special purpose microprocessors or both, or any other kind of central processing unit. Generally, a central processing unit will receive instructions and data from a read-only memory, a random access memory, or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer-readable media suitable for storing computer program instructions and data include all forms of non-volatile memory, media, and memory devices, including way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special-purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship between client and server arises by virtue of computer programs running on the respective computers and having a client-server relationship with each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

### Terminology

The phraseology and terminology used herein are for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,”when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Each numerical value presented herein, for example, in a table, a chart, or a graph, is contemplated to represent a minimum value or a maximum value in a range for a corresponding parameter. Accordingly, when added to the claims, the numerical value provides express support for claiming the range, which may lie above or below the numerical value, in accordance with the teachings herein. Absent inclusion in the claims, each numerical value presented herein is not to be considered limiting in any regard.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. The features and functions of the various embodiments may be arranged in various combinations and permutations, and all are considered to be within the scope of the disclosed invention. Accordingly, the described embodiments are to be considered in all respects as only illustrative and not restrictive. Furthermore, the configurations, materials, and dimensions described herein are intended as illustrative and in no way limiting. Similarly, although physical explanations have been provided for explanatory purposes, there is no intent to be bound by any particular theory or mechanism, or to limit the claims in accordance therewith.

What is claimed is:

1. A method for automatically generating prompts, the method comprising:
providing user input to one or more large language models (LLMs) utilizing meta prompting to generate a set of prompts represented by a plurality of vectors;
identifying, by the one or more LLMs, a plurality of differential vectors from pairs of prompt vectors selected from the plurality of vectors representing the set of prompts;
mutating, by the one or more LLMs, the plurality of vectors representing the set of prompts with the plurality of differential vectors and using one or more first algorithms to determine one or more mutated prompt vectors;
generating an intermediate prompt, using the one or more LLMs, by combining the one or more mutated prompt vectors with the plurality of vectors representing the set of prompts and selecting a prompt vector representing the intermediate prompt using one or more second algorithms;
dividing a task of validating the intermediate prompt into a plurality of subtasks to be respectively performed by each of a plurality of software-based agents;
performing the plurality of subtasks by the plurality of software-based agents as part of a chain of thought (CoT) process to validate the intermediate prompt and output one or more suggestions for prompt modification; and
generating a final prompt by refining the intermediate prompt using the one or more suggestions.

2. The method of claim 1, wherein the one or more algorithms are applied to ensure each differential portion obtained from the one or more LLMs is included in the one or more mutated prompt vectors.

3. The method of claim 1, wherein the one or more algorithms include an objective function.

4. The method of claim 1, wherein outputting the one or more suggestions comprises:
using the one or more LLMs to execute the intermediate prompt on validation data and generate an execution result, wherein the validation data is different from the user input;
analyzing the intermediate prompt based on the execution result; and
outputting the one or more suggestions by the one or more LLMs from analyzing the intermediate prompt.

5. The method of claim 1, wherein the set of prompts, the intermediate prompt, and the final prompt are generated based on the one or more LLMs receiving and recognizing domain-specific data using the CoT.

6. The method of claim 1, further comprising:
dynamically creating a plurality of test cases using the one or more LLMs; and
evaluating the final prompt based on executing the final prompt on test data of the plurality of test cases.

7. The method of claim 6, further comprising:
generating an evaluation score based on evaluation of the final prompt on the plurality of test cases; and
presenting the final prompt to a user when the evaluation score exceeds a threshold score.

8. The method of claim 7, further comprising:
receiving user feedback to refine the final prompt when the evaluation score does not exceed the threshold score.

9. The method of claim 8, wherein the final prompt is refined by adjusting hyperparameters of the LLMs or manually enhancing the final prompt with domain-related information.

10. The method of claim 1, further comprising iterating one or more of steps including providing, identifying, mutating, generating the intermediate prompt, dividing, performing, and generating the final prompt.

11. A system for automatically generating prompts, the system comprising:
a processor; and
a memory in communication with the processor and comprising instructions which, when executed by the processor, program the processor to:
provide user input to one or more large language models (LLMs) utilizing meta prompting to generate a set of prompts represented by a plurality of vectors;
identify, by the one or more LLMs, a plurality of differential vectors from pairs of prompt vectors selected from the plurality of vectors representing the set of prompts;
mutate, by the one or more LLMs, the plurality of vectors representing the set of prompts with the plurality of differential vectors and use one or more first algorithms to determine one or more mutated prompt vectors;
generate an intermediate prompt, using the one or more LLMs, by combining the one or more mutated prompt vectors with the plurality of vectors representing the set of prompts and selecting a prompt vector representing the intermediate prompt using one or more second algorithms;
divide a task of validating the intermediate prompt into a plurality of subtasks to be respectively performed by each of a plurality of software-based agents;
perform the plurality of subtasks by the plurality of software-based agents as part of a chain of thought (CoT) process to validate the intermediate prompt and output one or more suggestions for prompt modification; and
generate a final prompt by refining the intermediate prompt using the one or more suggestions.

12. The system of claim 11, wherein the one or more algorithms are applied to ensure each differential portion obtained from the one or more LLMs is included in the one or more mutated prompt vectors.

13. The system of claim 11, wherein the one or more algorithms include an objective function.

14. The system of claim 11, wherein to output the one or more suggestions, the instructions further program the processor to:
use the one or more LLMs to execute the intermediate prompt on validation data and generate an execution result, wherein the validation data is different from the user input;
analyze the intermediate prompt based on the execution result; and
output the one or more suggestions by the one or more LLMs from analyzing the intermediate prompt.

15. The system of claim 11, wherein the set of prompts, the intermediate prompt, and the final prompt are generated based on the one or more LLMs receiving and recognizing domain-specific data using the CoT.

16. The system of claim 11, wherein the instructions further program the processor to:
dynamically create a plurality of test cases using the one or more LLMs; and
evaluate the final prompt based on executing the final prompt on test data of the plurality of test cases.

17. The system of claim 16, wherein the instructions further program the processor to:
generate an evaluation score based on evaluation of the final prompt on the plurality of test cases; and
present the final prompt to a user when the evaluation score exceeds a threshold score.

18. The system of claim 17, wherein the instructions further program the processor to receive user feedback to refine the final prompt when the evaluation score does not exceed the threshold score.

19. The system of claim 11, wherein the instructions further program the processor to iterate one or more of steps including providing, identifying, mutating, generating the intermediate prompt, dividing, performing, and generating the final prompt.

20. A computer program product for automatically generating prompts, the computer program product comprising a non-transitory computer readable medium having computer readable program code stored thereon, the computer readable program code configured to:
provide user input to one or more large language models (LLMs) utilizing meta prompting to generate a set of prompts represented by a plurality of vectors;
identify, by the one or more LLMs, a plurality of differential vectors from pairs of prompt vectors selected from the plurality of vectors representing the set of prompts;
mutate, by the one or more LLMs, the plurality of vectors representing the set of prompts with the plurality of differential vectors and use one or more first algorithms to determine one or more mutated prompt vectors;
generate an intermediate prompt, using the one or more LLMs, by combining the one or more mutated prompt vectors with the plurality of vectors representing the set of prompts and selecting a prompt vector representing the intermediate prompt using one or more second algorithms;
divide a task of validating the intermediate prompt into a plurality of subtasks to be respectively performed by each of a plurality of software-based agents;
perform the plurality of subtasks by the plurality of software-based agents as part of a chain of thought (CoT) process to validate the intermediate prompt and output one or more suggestions for prompt modification; and
generate a final prompt by refining the intermediate prompt using the one or more suggestions.
